(19) United States
(12) Patent Application Publication
(10) Pub. No.: US 2015/0066458 A1
(43) Pub. Date: Mar. 5, 2015

(54) PROVIDING AN OBJECTIVE FUNCTION BASED ON VARIATION IN PREDICTED DATA

(71) Applicant: WESTERNGECO L.L.C., Houston, TX (US)

(72) Inventors: Darrell Coles, Katy, TX (US); Hugues A. Djikpesse, Cambridge, MA (US); Michael David Prange, Somerville, MA (US); Richard Coates, Katy, TX (US)

(21) Appl. No.: 14/389,346

(22) PCT Filed: Mar. 28, 2013
(86) PCT No.: PCT/US2013/034193

§ 371 Date: Sep. 29, 2014

Related U.S. Application Data
(60) Provisional application No. 61/616,499, filed on Mar. 28, 2012.

(51) Int. Cl. G01V 1/42; G01V 3/30

(52) U.S. Cl. CPC G01V 1/42; G01V 3/30
USPC 703/2

(57) ABSTRACT

An objective function is based on covariance of differences in predicted data over multiple sets of candidate model parameterizations that characterize a target structure. A computation is performed with respect to the objective function to produce an output. An action selected from the following can be performed based on the output of the computation: selecting at least one design parameter relating to performing a survey acquisition that is one of an active source survey acquisition and a non-seismic passive acquisition, and selecting a data processing strategy.

### CROSS-REFERENCE TO RELATED APPLICATION

This application claims the benefit under 35 U.S.C. §119(e) of U.S. Provisional Application Ser. No. 61/616,499, entitled “SURVEY DESIGN FOR MARINE BOREHOLE SEISMICS,” filed Mar. 28, 2012, which is hereby incorporated by reference.

### BACKGROUND

Surveys can be performed to acquire survey data regarding a target structure, such as a subsurface structure. Examples of surveys that can be performed include seismic surveys, electromagnetic (EM) surveys, wellbore surveys, and so forth. In a survey operation, one or more survey sources are used to generate survey signals (e.g. seismic signals, EM signals, etc.) that are propagated into the subsurface structure. Survey receivers are then used to measure signals reflected from or affected by the subsurface structure.

The acquired survey data can be processed to characterize the subsurface structure. Based on the characterization, decisions can be made with respect to operations to be performed with respect to the subsurface structure, including additional survey operations, drilling of a wellbore, completion of a wellbore, and so forth.

An issue associated with obtaining information based on survey data is uncertainty associated with models that characterize the subsurface structure. Failing to properly consider model uncertainty can lead to increased risks as part of decision-making associated with operations performed with respect to a subsurface structure.

### SUMMARY

In general, according to some implementations, an objective function is based on variation in predicted data over multiple sets of candidate model parameterizations that characterize a target structure. A computation is performed with respect to the objective function to produce an output. An action is performed that is selected from the group consisting of: selecting, using the output of the computation, at least one design parameter relating to performing a survey acquisition that is one of an active source survey acquisition and a non-seismic passive survey acquisition; and selecting, using the output of the computation, a data processing strategy.

In general, according to further or other implementations, the objective function is based on covariance of differences in the predicted data over the multiple sets of candidate model parameterizations.

In general, according to further or other implementations, the objective function is maximized.

In general, according to further or other implementations, maximizing the objective function comprises maximizing a nonlinear objective function.

In general, according to further or other implementations, maximizing the nonlinear objective function comprises maximizing a D_{N}-criterion.

In general, according to further or other implementations, the at least one design parameter relating to performing the survey acquisition is selected to increase expected information in data acquired by the survey acquisition.

In general, according to further or other implementations, the data acquired by the survey acquisition is selected from the group consisting of seismic data, electromagnetic data, data acquired by a cross-well survey acquisition, data acquired by an ocean-bottom cable acquisition arrangement, data acquired by a vertical seismic profile (VSP) survey acquisition arrangement, gravity data, geodetic data, laser data, and satellite data.

In general, according to further or other implementations, selecting the at least one design parameter comprises selecting a parameter defining an offset of a survey source to a wellhead of a wellbore in which survey equipment is provided.

In general, according to further or other implementations, selecting the at least one design parameter comprises defining a region in which a spiral survey operation is performed.

In general, according to further or other implementations, selecting the at least one design parameter further comprises defining a rate of increase of a radius of a spiral pattern for the spiral survey operation.

In general, according to further or other implementations, selecting the at least one design parameter comprises selecting a design parameter for a time-lapse survey.

In general, according to further or other implementations, selecting the at least one design parameter relates to a survey data acquisition operation for survey-guided drilling of a wellbore.

In general, according to further or other implementations, selecting the at least one design parameter comprises modifying the at least one design parameter of a survey arrangement as the survey acquisition is being performed.

In general, according to further or other implementations, selecting the data processing strategy comprises selecting one or more subsets of a dataset containing acquired survey data, where the selected one or more subsets of data are processed.

In general, according to further or other implementations, the processing is selected from the group consisting of a full waveform inversion, reverse time migration processing, least squares migration processing, tomography processing, velocity analysis, noise suppression, seismic attribute analysis, static removal, and quality control at a control system.

In general, according to some implementations, a computer system includes at least one processor to provide an objective function based on a variation in predicted data over multiple sets of candidate model parameterizations that characterize a target structure, and perform a computation with respect to the objective function to produce an output. An action is performed that is selected from the group consisting of: selecting, using the output of the computation, at least one design parameter relating to performing a survey acquisition that is one of an active source survey acquisition and a non-seismic passive survey acquisition; and selecting, using the output of the computation, a data processing strategy.

In general, according to further or other implementations, the computation computes values pertaining to a D_{N}-criterion, wherein the values identify positions of shots that are more likely to produce more informative data.

Other or alternative features will become apparent from the following description, from the drawings, and from the claims.

### BRIEF DESCRIPTION OF THE DRAWINGS

Some embodiments are described with respect to the following figures:

FIG. 1 is a block diagram of an example arrangement that includes survey equipment and a computer system for performing processing according to some implementations;

FIG. 2 is a flow diagram of a process according to some implementations;

FIGS. 3A-3B are graphs of values based on performing a computation with respect to an objective function according to some implementations;

FIG. 4 is a graph illustrating a survey performed using a Z pattern derived based on an output of performing a computation with respect to an objective function according to some implementations; and

FIG. 5 is a block diagram of components of a computer system according to some implementations.

### DETAILED DESCRIPTION

Statistical experimental design (SED) techniques can be applied to reduce (or minimize) risks associated with model uncertainty. Model uncertainty is based on the fact that a model may not actually be an accurate representation of a target structure, such as a subsurface structure. An SED technique enhances experiments to improve (or maximize) the expected information that can be obtained in observed data.

Model-oriented design is a subdiscipline of SED. With a model-oriented design, information is obtained regarding how observed data can vary with models of the subsurface structure. With model-oriented design, model discrimination may be performed. The object of model discrimination is to perform experiments to discriminate between two or more models that describe a phenomenon of interest (e.g. a target structure such as a subsurface structure). In some implementations, a hypothesis test may be enhanced by model-oriented design. Two hypotheses are proposed that provide two competing models to explain observed data. An experiment can be defined that increases (or maximizes) the odds that one model is correct and the other model is incorrect. The correct or true model can be considered the null hypothesis, while the other model is treated as an alternate hypothesis. Stated differently, a goal of the hypothesis test is to optimize an experiment to increase (or maximize) the odds that the alternative hypothesis is rejected, which ensures that the model parameters most likely to explain an observed data are in fact the correct ones.

In accordance with some implementations, a nonlinear design objective function relating to an experimental design (and more specifically to a model-oriented design) is used for reducing (or minimizing) risk associated with uncertainty, such that the expected information that can be obtained from observed data can be increased (or maximized). In some implementations, the non-linear design objective function that is used includes a D_{N}-criterion.

Nonlinear model-oriented design relates to nonlinear data-model relationships, in which the information content of data varies nonlinearly with the model of the target structure. It is desirable to address nonlinearity because many data-model relationships (represented by theoretical functions) in subsurface exploration are nonlinear and affect model uncertainty in complicated ways.

The D_{N}-criterion is a nonlinear design objective function that can be maximized using relatively efficient algorithms from linearized design theory. This makes the D_{N}-criterion capable of optimizing large-scale experiments (that can contain a relatively large amount of data).

Maximizing the D_{N}-criterion, where “criterion” refers to “objective function,” produces experiments that are expected to optimally discriminate between competing model parameterizations. A parameterization of a model refers to assigning values to one or more parameters of the model. Different parameterizations involve assigning different values to the parameter(s). For example, a model can include a velocity parameter, which represents a velocity of a seismic wave. A model can include different values of the velocity parameter at different geometric points for characterize respective portions of the subsurface structure. In other examples, a model can include additional or alternative parameters, such as a density parameter, a resistivity parameter, and so forth.

In the ensuing discussion, reference is made to subsurface structures that may contain items that are of interest, such as hydrocarbon reservoirs, fresh water aquifers, and so forth. However, in other examples, techniques or mechanisms according to some implementations can also be applied to other types of target structures, such as human tissue, mechanical structures, structures relating to mining, and so forth.

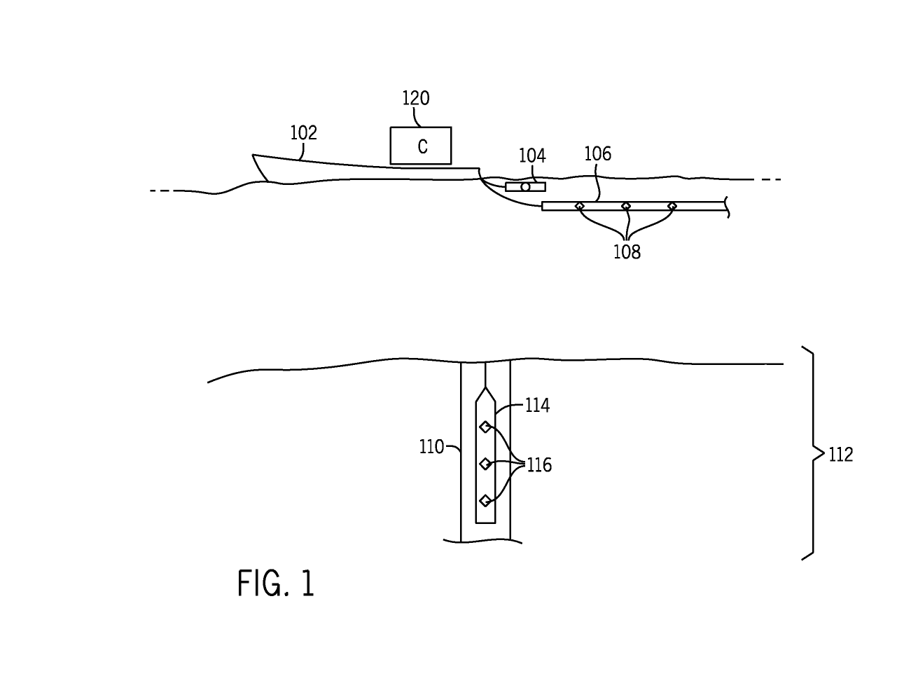

FIG. 1 is a schematic diagram of a survey arrangement that includes a marine vessel 102 that is able to tow, through a body of water, one or more survey sources 104 and a streamer 106 that includes survey receivers 108.

In addition, a wellbore 110 can be drilled into a subsurface structure 112. A survey string 114 can be deployed in the wellbore 110, where the survey string 114 can include survey receivers 116. In some examples, the streamer 106 can be omitted. In other examples, the survey source(s) 104 can be omitted. Also, instead of, or in addition to, providing the survey receivers 116 in the survey string 114, one or more survey sources can also be provided in the survey string 114.

In examples where the survey sources and survey receivers of the arrangement of FIG. 1 are seismic sources and seismic receivers, the arrangement depicted in FIG. 1 allows for acquiring data to determine a vertical seismic profile (VSP) of the subsurface structure 112. By using seismic receivers 116 that are deployed in the wellbore 110, whose depths are known, a more accurate profile of a parameter of the subsurface structure 112 can be obtained. An example profile can be a velocity profile. However, in other examples, profiles of other parameters can be obtained.

In other example arrangements in which the wellbore 110 and survey string 114 are omitted, the survey arrangement of FIG. 1 would perform a surface survey arrangement, in which the characterization of the subsurface structure 112 is based on measurements made above the subterranean structure 112. Also, instead of a survey arrangement that measures data above the subsurface structure 112, a different survey arrangement can perform cross-well measurements, in which survey source(s) are provided in a first wellbore and survey receivers are provided in a second wellbore. Survey signals generated by the survey source(s) in the first wellbore propagate through the subsurface structure for detection by survey receivers in the second wellbore. In further examples, a survey arrangement can use an ocean-bottom cable, which is a cable having survey receivers that is provided on a seafloor.

In further examples, the survey sources and survey receivers in a survey arrangement can include electromagnetic (EM) sources and EM receivers, which can be used in a controlled source EM (CSEM) survey operation. In addition, other types of survey sources and survey receivers can be employed in other implementations. For example, other survey receivers can measure gravity data, magnetotelluric data, geodetic data (to measure a shape of the earth), laser data, satellite data (e.g. global positioning system data or other type of satellite data), and so forth. In other examples, other types of data can be measured by survey receivers.

Although reference is made to an example marine survey arrangement, it is noted that techniques or mechanisms according to some implementations can also be applied to land-based survey arrangements, cross-well survey arrangements (where survey source(s) are placed in a first wellbore and survey receivers are placed in a second wellbore).

FIG. 1 also shows a computer system 120 provided on the marine vessel 102. The computer system 120 can control activation of the survey source 104. The computer system 120 can also receive data acquired by the survey receivers 108.

In some examples, the computer system 120 is also able to perform processing of the data acquired by the survey receivers 108 and 116. Alternatively, the computer system 120 for performing processing according to some implementations can be located remotely from the marine vessel 102, such as at a land-based facility.

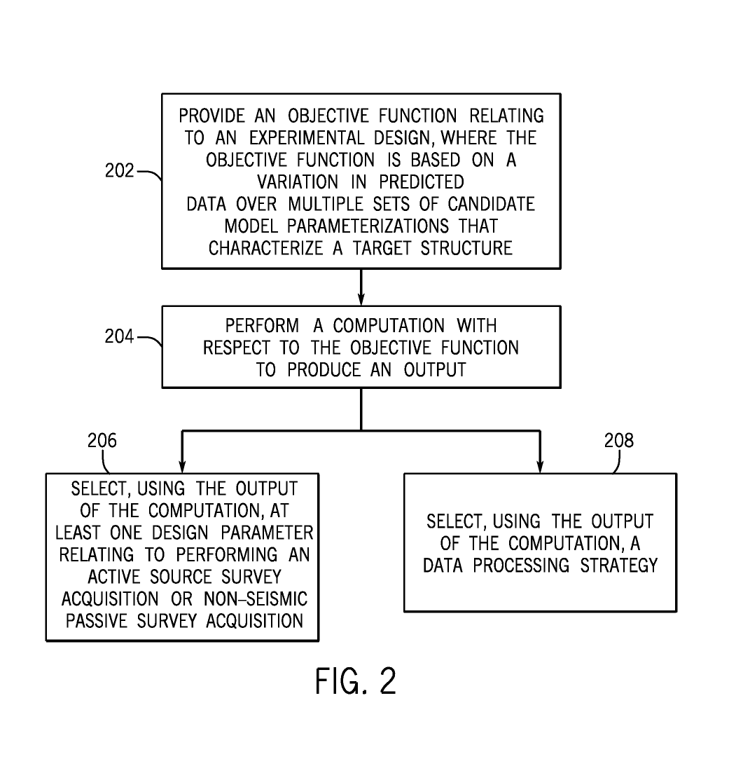

FIG. 2 is a flow diagram of a process that can be performed by the computer system 120, according to some implementations. The process of FIG. 2 provides (at 202) an objective function relating to an experimental design. In some examples, the objective function can be the D_{N}-criterion discussed in further detail below. Generally, the objective function is based on variation in predicted data over multiple sets of candidate model parameterizations that characterize a target structure. More specifically, the objective function is based on covariance of differences in predicted data over multiple sets of candidate model parameterizations that characterize a target structure. Covariance describes how different collections of data vary with each other.

The process performs (at 204) a computation with respect to the objective function to produce an output. In some implementations, performing the computation with respect to the objective function includes maximizing the objective function, such as maximizing the D_{N}-criterion, which is discussed further below.

Based on the output of the computation performed with respect to the objective function, one or both of tasks 206 and 208 can be performed. Task 206 includes selecting at least one design parameter relating to performing an active source survey acquisition or a non-seismic passive survey acquisition, where the selecting uses the output of the computation performed with respect to the objective function. An active source survey acquisition refers to a survey acquisition performed using a survey arrangement, such as that depicted in FIG. 1, in which one or more survey sources are controlled to generate survey signals (e.g. seismic signals or EM signals) that are propagated into the subsurface structure 112. An active source survey acquisition differs from a passive survey acquisition, in which survey data is acquired without using an active survey source. A non-seismic passive survey acquisition refers to a survey acquisition that does not involve measuring seismic data. Examples of non-seismic passive survey acquisitions include acquisitions of magnetotelluric data, gravity data, geodetic data (for determining the shape of the earth), or acquisition of other types of non-seismic data.

A design parameter relating to performing a survey acquisition can refer to any parameter that defines how the survey is performed. For example, a design parameter can define a path or a location in which survey source(s) and/or survey receiver(s) is (are) to be provided. Another design parameter can define the type of survey to be performed. As yet another example, a design parameter can define how long a survey is to be performed. There can be numerous other design parameters associated with a survey acquisition (active source survey acquisition or non-seismic passive acquisition).

Task 208 involves the selection of a data processing strategy to be employed with respect to survey data acquired in a survey acquisition. The selection uses the output of the computation performed with respect to the objective function.

In some examples, selecting the data processing strategy includes selecting one or more subsets (where each subset is less than the entirety) of data acquired in the survey acquisition. Selecting subset(s) of acquired data for processing allows for more efficient processing, since the total acquired data can include a relatively large amount of data that can be computationally expensive to process.

In other examples, selecting the data processing strategy can include selecting a strategy for attenuating noise (such as to attenuate surface noise), selecting a strategy relating to migration of acquired data, selecting a strategy relating to filtering data, selecting a strategy relating to analyzing a parameter (or parameters) of interest, and so forth. Multiple candidate data processing strategies may be available, and the selection at 208 can include selecting from among the multiple candidate data processing strategies for processing the acquired data.

As noted above, performing the computation (at 204) with respect to the objective function includes maximizing the D_{N}-objective, in some implementations. Although the following describes details associated with use of the D_{N}-objective, it is noted that in other implementations, other types of objective functions can be used, where such objective functions are based on covariance of differences in predicted data over multiple sets of candidate model parameterizations that characterize the subsurface structure.

Maximizing the D_{N}-criterion produces experiments that are expected to optimally discriminate between competing model parameterizations that characterize the subsurface structure. Maximizing model discriminability over multiple model parameterizations is equivalent to minimizing the expected model uncertainty. Thus, the D_{N}-criterion can be considered to measure experimental quality.

The following provides details relating to derivation of the D_{N}-criterion according to some implementations.

Let

d(m,ξ)=g(m,ξ)+ε(m,ξ) (Eq. 1)

be a mathematical model of interest, where d is a vector of data observations made at observation points (geometric coordinates), m is a vector of model parameters, g is a deterministic theoretical function relating d and m, and ε is a vector of stochastic measurement errors.

It is assumed that m (which is a vector of model parameters) has a known prior distribution, ρ(m), which characterizes the state of knowledge about m before any new data is acquired. Likewise, it is assumed that ε has a known distribution, such as a probability distribution function (PDF).

A discriminating test that can be used in experimental design is a log-likelihood-ratio test, which expresses the odds ratio of the null and alternative hypothesis. The likelihood-ratio test, or its logarithm (referred to as the log-likelihood-ratio test), considers the ratio of the likelihoods of a null hypothesis and an alternative hypothesis, and thus is effectively an odds ratio. The likelihood-ratio test expresses how much more likely it is that the data is explained by one model parameterization than by another model parameterization. Maximizing the likelihood-ratio maximizes the odds that the alternative hypothesis is rejected, which is equivalent to maximizing the odds that the true model parameterization is accepted.

Denoting the true model parameterization and its corresponding data by m₀ and d₀ (or g(m₀)+ε), respectively, and denoting an alternative model parameterization m₁, the log-likelihood-ratio can be expressed as:

$$\begin{matrix}ln Λ = ln \frac{L [ g ( {m}_{0} ) + ɛ \vert {m}_{0} ]}{L [ g ( {m}_{0} ) + ɛ \vert {m}_{1} ]} , or alternatively & ( Eq . 2 a ) \\ ln Λ = ln \frac{L ( {d}_{0} \vert {m}_{0} )}{L ( {d}_{0} \vert {m}_{1} )} , & ( Eq . 2 b )\end{matrix}$$

where L is the data likelihood function (dependence on ξ is suppressed for ease of notation). Maximizing Λ with respect to ξ maximizes the odds that the true model, m₀, is accepted and the alternative model parameterization, m₁, is rejected.

The log-likelihood ratio in Eq. 2a or 2b is defined for a single pair of m₀ and m₁, Note that there can be a relatively large number of model parameterizations that have to be compared using the log-likelihood ratio test. In some implementations, a Bayesian approach in which the hypothesis test does not depend on a single pair of model parameterizations but is integrated over a plurality of probable model parameterizations). This leads to taking the expectation of ln Λ over m₀ and m₁,

$${E}_{π} ln Λ = \int π ( {m}_{0} , {m}_{1} ) ln \frac{L ( {d}_{0} \vert {m}_{0} )}{L ( {d}_{0} \vert {m}_{1} )} d {m}_{0} d {m}_{1} , \qquad ( Eq . 3 )$$

where π(m₀,m₁)=ρ(m₀)ρ(m₁) can be viewed as the joint distribution of m₀ and m₁, noting that m₀ and m₁ may be treated as statistically independent when they are treated as independent variables in Eq. 3. E_{π} is the expectation operator over the joint distribution of m₀ and m₁, where the joint distribution is expressed as π(m₀,m₁)=ρ(m₀)ρ(m₁).

Maximizing the average log-likelihood ratio in Eq. 3 should therefore maximize the odds that the true model parameterization is accepted over candidate alternative model parameterizations.

When ε is Gaussian with zero mean and covariance, C_{d}, it can be shown that Eq. 3, simplifies to

$${E}_{π} ln Λ = {E}_{π} ln \frac{exp [ - \frac{1}{2} {( {g}_{0} + ɛ - {g}_{0} )}^{T} {C}_{d}^{- 1} ( {g}_{0} + ɛ - {g}_{0} ) ]}{exp [ - \frac{1}{2} {( {g}_{0} + ɛ - {g}_{1} )}^{T} {C}_{d}^{- 1} ( {g}_{0} + ɛ - {g}_{1} ) ]} , \qquad ( Eq . 4 )$$

which simplifies to

E_{π}ln Λ=½E_{π}(g₀−g₁)^{T}C_{d}⁻¹(g₀−g₁). (Eq. 5)

and defining

δ≡C_{d}^{-1/2}(g₀−g₁), (Eq. 6)

can be further simplified to

E_{π}ln Λ=E_{π}½δ^{T}δ=E_{π}½trδδ^{T}=½trE_{π}δδ^{T}. (Eq. 7)

Effectively, Eqs. 5 and 7 provide a hypothesis test over multiple pairs of candidate model parameterizations (or more generally, multiple sets of candidate parameterizations), where a pair is includes m₀ and m₁. More generally, Eqs. 5 and 7 represent a covariance matrix that describes how predicted data (based on corresponding model parameterizations) vary with respect to each other.

If E_{π}δδ^{T} has any zero eigenvalues then there has to exist some m₀≠m₁ for which C_{d}^{-1/2}(g₀−g₁) is parallel to the null vector(s) of E_{π}δδ^{T}, resulting in a perfect match between g₀ and g₁ despite m₀ not equaling m₁, which can lead to non-uniqueness.

To address the foregoing non-uniqueness issue, eigenvalues can be forced to be nonzero, which can lead to achieving data-model uniqueness. To do this, log eigenvalues can be summed. This sum is automatically negative infinity for any experiment that causes E_{π}δδ^{T} to be singular, which has the effect of eliminating those experiments as potential optima. This is essentially an additional criterion for the objective function according to some implementations. A first criterion is still to maximize the expected log likelihood ratio; a second criterion is to ensure that the maximizing experiment honors the degrees of freedom in the data-model relationship (inasmuch as this is achievable). The sum of the log eigenvalues of a matrix is equal to the log of the determinant of that matrix, which gives the objective function

Φ=ln det(E_{π}δδ^{T}), (Eq. 8)

which is the D_{N}-criterion. Note that this derivation allows g₀−g₁ to be non-Gaussian. Note also that det E_{π}δδ^{T} is the so-called generalized variance of δ. This derivation avoids the assumption that g(m₀)−g(m₁) is multivariate Gaussian (multinormal).

The D_{N}-criterion thus includes two objectives, one that maximizes the expected data likelihood ratio and the other that honors the degrees of freedom in the data-model relationship.

It is easier to discriminate between competing model parameterizations (for explaining observed data), if the predicted data vary greatly from model parameterization to model parameterization. Also, it is easier to discriminate between model parameterizations if their predicted data are expected to vary independently of one another. Looked at the other way round, if different model parameterizations predict nearly the same data, then, accounting for measurement noise, it may be difficult to discriminate which model parameterization best explains the observed data. Likewise, it may be difficult to discriminate between model parameterizations whose predicted data are perfectly correlated, because this creates the possibility that many model parameterizations can equally honor the observed data.

The D_{N}-criterion seeks to maximize data variability while minimizing data correlation.

Several optimization algorithms for maximizing the D_{N}-criterion can be used, including algorithms described in Darrell Coles et al., “A Free Lunch In Linearized Experimental Design?” Computers & Geosciences, pp. 1026-1034 (2011).

The algorithms described in Coles et al. are greedy in that a solution is optimized through a sequence of locally optimal updates in the hope that the result is close to the global optimum. A solution is optimized through a sequence of local updates which are optimal with respect to the current solution but not necessarily with respect to the global (overall) objective function.

Sequential algorithms can be formulated to use a recursion on the design objective function which relates its current value to its future value at a subsequent stage of the optimization. Such relations are often more efficient to evaluate than the objective function itself. In particular, the D-criterion, a linearized design objective function, can be defined as the determinant of the posterior model covariance matrix. The D_{N}-criterion is a generalization of the D-criterion to nonlinear data-model relationships, and there is a simple recursion formula (for both criteria) that obviates explicit computation of a determinant, replacing it with an efficient matrix-vector product. The recursion is simply a rank-k update formula for the determinant of a square symmetric matrix (e.g. the data covariance E_{π}δδ^{T}). Determinant-based design criteria can take advantage of the fact that the data covariance matrix of any subset of the candidate set of observed data is a principal submatrix (the matrix obtained by deleting similarly indexed rows and columns of a square matrix) of the data covariance matrix of the candidate set. Thus, it is sufficient to calculate E_{π}δδ^{T} once, for the complete candidate set of observation points, and then use the aforementioned rank-k update formulas to find the optimum (or improved) subset of observations.

As discussed in connection with FIG. 2, task 206 involves selecting at least one design parameter relating to performing an active source survey acquisition or a non-seismic passive acquisition. An example active source survey acquisition can be performed using an arrangement in which seismic receivers are deployed in a wellbore, such as in the arrangement depicted in FIG. 1. Thus, using techniques according to some implementations, an optimal wellbore seismic experiment can be designed that reduces (e.g. maximally reduces) the anisotropic model uncertainty for tomography (where tomography relates to developing an image of a subsurface structure).

In some examples, a model of a subsurface structure can be characterized by using an uncertainty workflow that can provide multiple candidate parameterizations of the model that is consistent with observed survey data. The candidate model parameterizations can be randomly sampled, to provide an ensemble (collection) of candidate model parameterizations that can be used in the process of FIG. 2. For example, each candidate model parameterization can be a three dimensional (3D) mesh of elastic properties, such as velocity, density, and so forth. Each 3D mesh can be centered at a wellhead above the wellbore, such as wellbore 110 in FIG. 1. The model ensemble (including candidate model parameterizations) can be used as prior information by a D_{N}-optimizer that performs optimization of the D_{N}-criterion.

Because D_{N}-optimization operates in the data space, seismic wave (e.g. compression or P-wave) travel times for candidate combinations of shots, receivers, and models are computed, which can provide a relatively large number of data points. A “shot” refers to a particular activation of at least one survey source, which produces a survey signal that is propagated through a subsurface structure, where reflected or affected signals can be detected by survey receivers.

In some cases, missing data points can result from the presence of certain structures (e.g. salt structures) in the subsurface structure. The presence of such structures may prevent a ray tracer from computing travel times. Because the D_{N}-criterion operates on a data covariance matrix (as expressed in Eqs. 5 and 7 described above, for example), it is helpful to find a statistically consistent way of computing covariances in the presence of missing data.

In some examples, each shot-receiver pair can be weighted according to the percentage of successful travel times computed for the shot-receiver pair (over a set of candidate models). For example, a shot-receiver pair where 100% of travel times can be computed can be given a weight of 1; a shot-receiver pair where 80% of travel times can be computed can be given a weight of 0.8; and so on. This approach ensures that the computed covariance matrix can be positive semi-definite, and it also builds in a bias toward shot-receiver combinations with high success rates (for which a relatively large percentage of travel times can be computed), which is desirable since these combinations are most likely to produce informative data in a real acquisition setting, given the current state of model uncertainty.

To maximize the D_{N}-objective according to Eq. 8, estimation of E_{π}δδ^{T} (used in Eq. 8) for the complete set of shot-receiver pairs can be performed as follows:
1. Define Ξ to be an indexed set of candidate shot-receiver combinations, where an indexed set refers to a set whose entries can be identified by an index.
2. Define M to be an indexed set of the candidate model parameterizations in a model ensemble.
3. Define G to be an indexed set of computed travel times over Ξ and M:

G≡{gₖ|gₖ=g(mₖ,Ξ),mₖεM}.
4. Define C_{d} to be the data noise covariance matrix (used in Eq. 5), scaled according to the weighting scheme described above. Assuming data noise is Gaussian with zero mean and standard deviation having s specific example value, such as 10 milliseconds (which characterizes the picking error), compute

$${C}_{d}^{- 1 / 2} ( i , j ) = \{ \begin{matrix}0.1 \sqrt{{w}_{i}} , i = j \\ 0 , otherwise\end{matrix} ,$$

where wᵢ is the success rate of the i^{th} source-receiver pair.
5. Compute the scaled data-difference matrix D such that (assuming there are 500 candidate model parameterizations in the model ensemble)

D(:,m)≡δₘ=C_{d}^{-1/2}(gₖ−gₗ), where m=500(k−1)+l and k,l=1, . . . , 500.
6. Estimate E_{π}δδ^{T} by computing

$${E}_{π} {δδ}^{T} ≅ \frac{1}{{500}^{2}} {\sum }_{m = 1}^{{500}^{2}} {δ}_{m} {δ}_{m}^{T} = \frac{1}{{500}^{2}} {DD}^{T} ,$$

recalling that DD^{T}=[δ₁ . . . δₘ . . . ][δ₁ . . . δₘ . . . ]^{T}=δδ₁^{T}+ . . . +δδₘ^{T}+ . . . . This estimation can be done by performing singular value decomposition on D and retaining the largest singular values and associated singular vectors. That is,

$${E}_{π} {δδ}^{T} ≅ \frac{1}{{500}^{2}} \tilde{U} {\tilde{Σ}}^{2} {\tilde{U}}^{T} ,$$

where Ũ and \tilde{Σ} are the retained left singular vectors and singular value matrix of D. Without loss of generality, the matrix Ũ\tilde{Σ} can then be passed to a sequential design algorithm for the survey optimization.

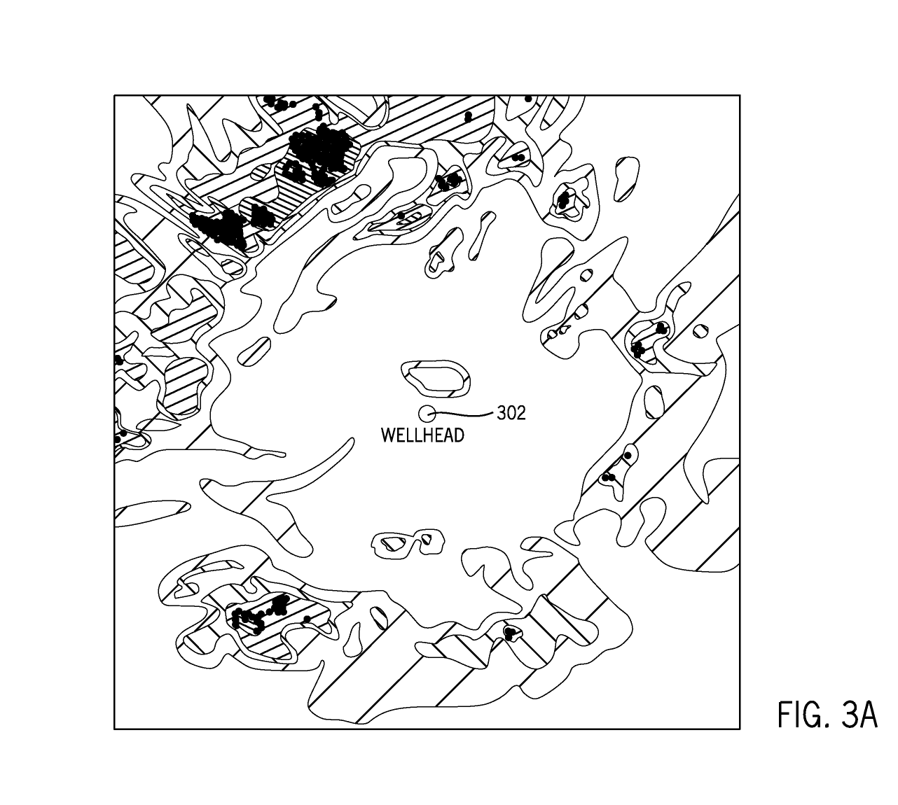

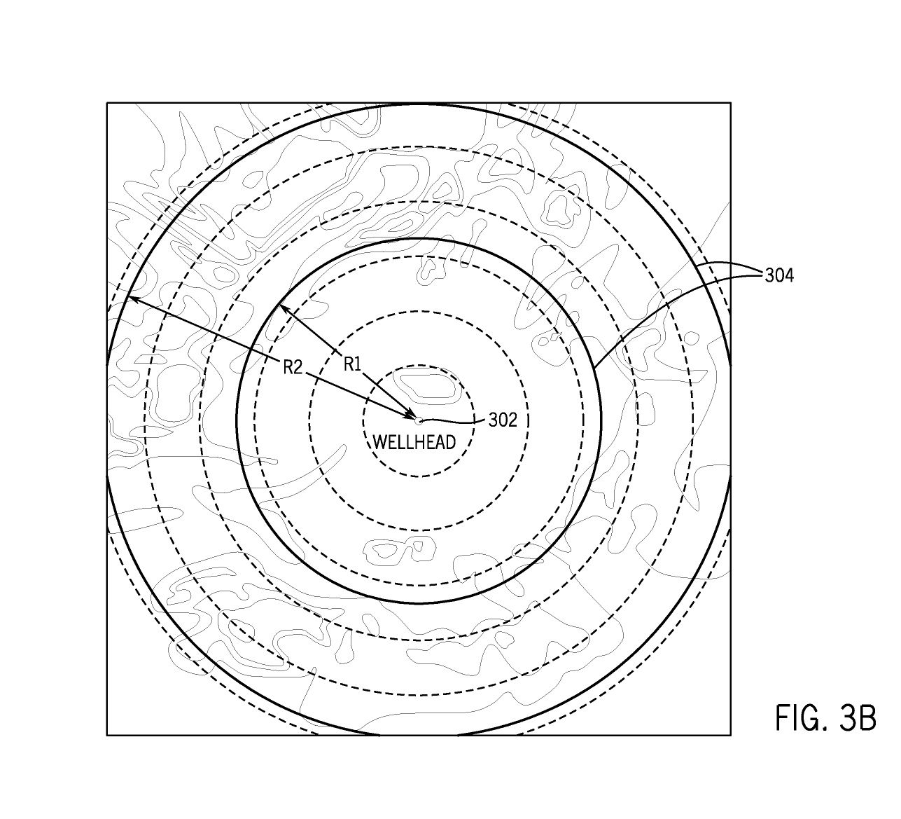

As noted above, the D_{N}-criterion seeks to maximize data variability (e.g. travel time variability) while minimizing data correlation (e.g. spatial correlation of travel times of a candidate shot with respect to an entire shot carpet). FIG. 3A depicts D_{N}-values (values of the D_{N}-criterion represented by Eq. 8 above) as a function of position in a horizontal plane. The white dot in FIG. 3A represents a wellhead 302, which can be the wellhead for the wellbore 110 of FIG. 1. Different D_{N}-values can be represented by different colors or other indicators (such as different gray scales, different patterns, etc.). In FIG. 3A, different D_{N}-values are represented as different patterns. More dense hash patterns depict higher D_{N}-values, while less dense hash patterns depict lower D_{N}-values.

The D_{N}-values of FIG. 3A are produced based on optimization of the D_{N}-criterion of Eq. 8 over survey data simulated over a large number of shots. In FIG. 3A, each shot is represented as a black dot.

Higher D_{N}-values depicted in FIG. 3A indicate more optimal shot positions. A shot position refers to a position where at least one survey source (e.g. 104 in FIG. 1) is activated. Thus, based on the graph of FIG. 3A, it can be determined that an annular region (such as annular region 304 shown in FIG. 3B), can be defined that correspond to the more optimal shot locations. Thus, a survey operator can use the results represented in the graphs of FIGS. 3A-3B to select a region (e.g. annular region 304) in which a marine vessel (e.g. 102 in FIG. 1) is to be towed for shot activation.

The annular region 304 has an inner radius (from the wellhead 302) of R1, and an outer radius of R2, as shown in FIG. 3B. It is expected that greater data variability (e.g. travel time variability) and reduced data correlation (e.g. spatial correlation of travel times of a candidate shot with respect to an entire shot carpet) can be obtained in regions shown in FIGS. 3A-3B of highest D_{N}-values. In other words, D_{N}-optimization will favor these regions. According to the graphs of FIGS. 3A-3B, shots closer than the radius R1 to the wellhead 302 are unlikely to produce informative data.

In some examples, a spiral three-dimensional (3D) VSP survey acquisition operation can be performed. A spiral 3D VSP survey acquisition operation involves towing at least one survey source (e.g. 104 in FIG. 1) in a spiral pattern starting at some offset from the wellhead 302. According to the result of FIGS. 3A-3B, the spiral pattern can start at an offset that is about an R1 distance from the wellhead 302, and end at an offset that is about an R2 distance from the wellhead 302. Such a spiral pattern can also be referred to as an annular spiral pattern.

The ability to systematically recommend a specific region for spiral VSP is useful because it ensures that the most informative data is collected while reducing acquisition costs. In addition, the rate of increase of the radius of the spiral pattern can also be determined.

D_{N}-optimization can also be used to design can also be used to design a time-lapse survey acquisition operation. Time-lapse survey acquisition refers to performing data acquisition at different times over the same regions. D_{N}-optimization can define the time offsets at which the time-lapse survey acquisition is to be performed.

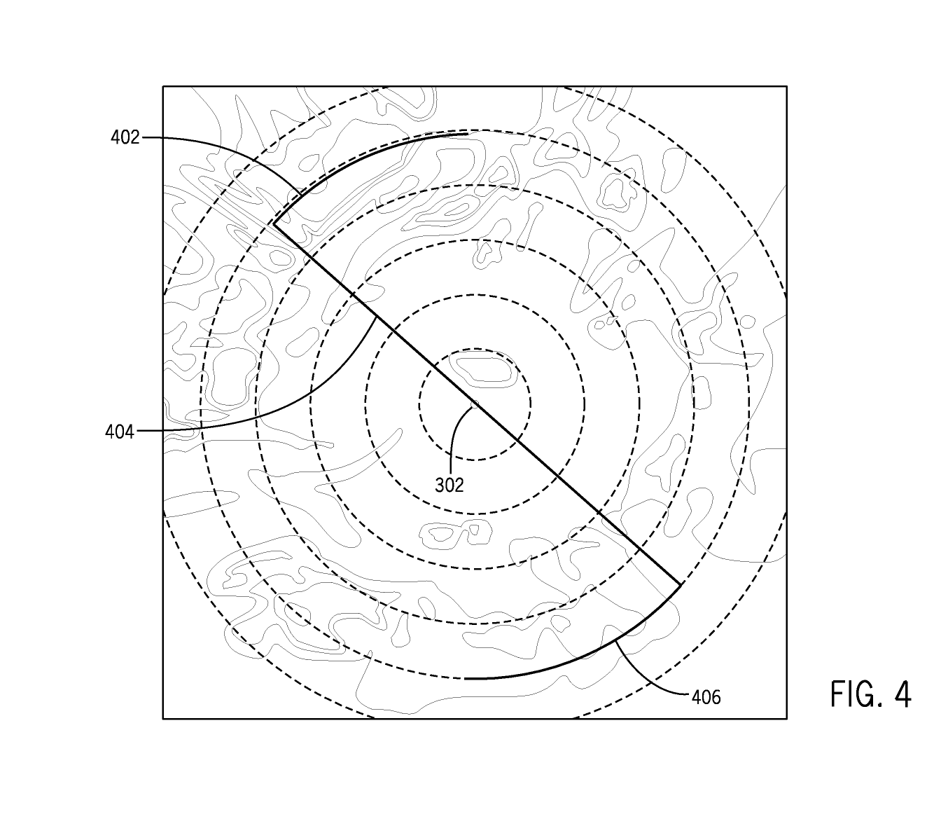

D_{N}-optimization can also be used to design a pre-survey acquisition geometry in which the expected measurement noise can be characterized to increase data quality during actual data acquisition. For example, a geometry referred to as a “Z-survey” can be designed for a survey data acquisition operation, where at least one survey source follows a general Z pattern, as depicted in FIG. 4. The Z pattern has a top segment 402, an intermediate diagonal segment 404, and a bottom segment 406; the three segments 402, 404, and 406 together form a reverse Z, in the example of FIG. 4. The Z-survey data acquisition operation can be a walkaway-azimuthal VSP acquisition operation, in which the top segment 402 of the Z pattern can be a first azimuthal segment through the “hot” region in the northwest of the FIG. 4 graph (where the “hot” region is a region associated with high D_{N}-values). The diagonal segment 404 can be a walkaway traversing the wellhead 302 to the bottom segment 406. The bottom segment 406 can be a second azimuthal segment through another region (which potentially can also be a “hot” region) in the southwest of the FIG. 4 graph. Such a geometry increases the likelihood that more informative data is acquired, which provides enhanced coverage for the characterization of noise and improves data quality.

Another use for D_{N}-optimization can be to produce real-time information maps for steering a marine vessel or to place the marine vessel in a vicinity where more informative shots are expected to occur. For example, the graph of FIG. 3A can be presented at the marine vessel, where an operator can guide the marine vessel to the regions of high D_{N}-values to perform shots.

In some examples, the ability to steer a marine vessel to locations that are likely to produce more informative data can be to identify far-offset checkshot positions to constrain look-ahead models in real-time drilling of a wellbore. A checkshot can be used to provide accurate time/depth correlation to give a confirmation of where a drillstring is in both time and depth, regardless of wellbore geometry, so that a drilling operator can quickly make informed drilling decisions in the wellbore.

D_{N}-optimization can also be used for post-acquisition quality control of acquired survey data. As discussed above, in some examples, the more informative shots occur in the annular region 304 depicted in FIG. 3B. Shots activated in this annular region 304 provide more informative data that can be processed (e.g. inverted) to characterize the subsurface structure, such as by producing an interim model that can be quickly looked at by an analyst as the model is being generated based on the acquired data.

D_{N}-optimization can also be used to decimate a dataset containing acquired survey data, which can be too large to be practically analyzed or to be analyzed within a desired time interval. The idea would be to systematically find a suitably small subset (or subsets) of the dataset which can be used to develop a relatively accurate model parameterization of the subsurface structure, or any portion of the subsurface structure. Selecting subset(s) of the dataset can be used in various types of processing, including tomography, least squares migration, full waveform inversion, reverse time migration, velocity analysis, noise suppression, seismic attribute analysis, static removal, and quality control at a control system (such as on a marine vessel), and so forth. In other examples, other types of processing can be performed.

Apart from the applications noted above, D_{N}-optimization can also handle industrial-scale nonlinear design problems. The ability to probabilistically optimize experiments for the nonlinear case is desirable because posterior model distributions are complicated by nonlinearity and D_{N}-optimization accomplishes this while still being computationally feasible for real-world problems. In many real-world applications, the true posterior model distribution is non-Gaussian because the forward operator is nonlinear, and D_{N}-optimization properly accounts for this.

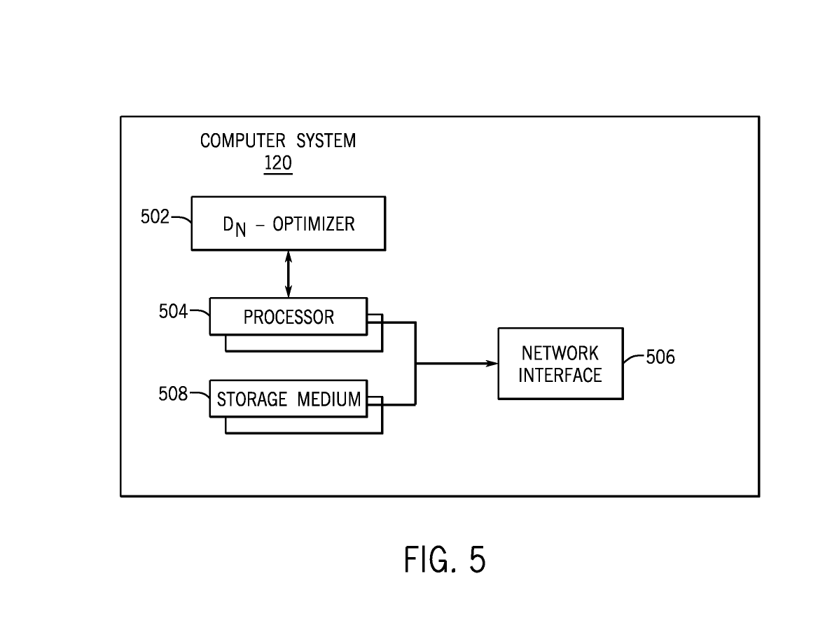

FIG. 5 is a block diagram of an example computer system 120 according to some implementations. The computer system includes a D_{N}-optimizer 502, which can perform various tasks discussed above, such as tasks depicted in FIG. 2 as well as other tasks described above. The D_{N}-optimizer 502 can be implemented as machine-readable instructions that can be loaded for execution on a processor or processors 505. A processor can include a microprocessor, microcontroller, processor module or subsystem, programmable integrated circuit, programmable gate array, or another control or computing device.

The processor(s) 504 can be connected to a network interface 506, which allows the computer system 120 to communicate over a network, such as to download data acquired by survey receivers. The processor(s) 504 can also be connected to a computer-readable or machine-readable storage medium (or storage media) 508, to store data and instructions. The storage media include different forms of memory including semiconductor memory devices such as dynamic or static random access memories (DRAMs or SRAMs), erasable and programmable read-only memories (EPROMs), electrically erasable and programmable read-only memories (EEPROMs) and flash memories; magnetic disks such as fixed, floppy and removable disks; other magnetic media including tape; optical media such as compact disks (CDs) or digital video disks (DVDs); or other types of storage devices. Note that the instructions discussed above can be provided on one computer-readable or machine-readable storage medium, or alternatively, can be provided on multiple computer-readable or machine-readable storage media distributed in a large system having possibly plural nodes. Such computer-readable or machine-readable storage medium or media is (are) considered to be part of an article (or article of manufacture). An article or article of manufacture can refer to any manufactured single component or multiple components. The storage medium or media can be located either in the machine running the machine-readable instructions, or located at a remote site from which machine-readable instructions can be downloaded over a network for execution.

Those with skill in the art will appreciate that while some embodiments discussed herein include terms that could be interpreted as potentially absolute or requiring a given thing (e.g., including without limitation “exactly”, “exact”, “only”, “key”, “important”, “requires”, “all”, “maximizing”, “maximum”, “each”, “minimize”, “minimum”, “must”, “always”, etc.), the various systems, methods, processing procedures, techniques, and workflows disclosed herein are not to be understood as limited by the use of those terms, nor are any claims that issue from this patent application necessarily limited by the use of those terms.

In the foregoing description, numerous details are set forth to provide an understanding of the subject disclosed herein. However, implementations may be practiced without some or all of these details. Other implementations may include modifications and variations from the details discussed above. It is intended that the appended claims cover such modifications and variations.

What is claimed is:

1. A method comprising:
providing an objective function based on variation in predicted data over multiple sets of candidate model parameterizations that characterize a target structure;
performing a computation with respect to the objective function to produce an output; and
perform an action selected from the group consisting of: selecting, using the output of the computation, at least one design parameter relating to performing a survey acquisition that is one of an active source survey acquisition and a non-seismic passive survey acquisition; and selecting, using the output of the computation, a data processing strategy.

2. The method of claim 1, wherein providing the objective function comprises providing the objective function based on covariance of differences in the predicted data over the multiple sets of candidate model parameterizations.

3. The method of claim 1, wherein performing the computation comprises maximizing the objective function.

4. The method of claim 3, wherein maximizing the objective function comprises maximizing a nonlinear objective function.

5. The method of claim 4, wherein maximizing the nonlinear objective function comprises maximizing a D_{N}-criterion.

6. The method of claim 1, wherein selecting the at least one design parameter relating to performing the survey acquisition is to increase expected information in data acquired by the survey acquisition.

7. The method of claim 6, wherein the data acquired by the survey acquisition is selected from the group consisting of seismic data, electromagnetic data, data acquired by a cross-well survey acquisition, data acquired by an ocean-bottom cable acquisition arrangement, data acquired by a vertical seismic profile (VSP) survey acquisition arrangement, gravity data, geodetic data, laser data, and satellite data.

8. The method of claim 1, wherein selecting the at least one design parameter comprises selecting a parameter defining an offset of a survey source to a wellhead of a wellbore in which survey equipment is provided.

9. The method of claim 1, wherein selecting the at least one design parameter comprises defining a region in which a spiral survey operation is performed.

10. The method of claim 9, wherein selecting the at least one design parameter further comprises defining a rate of increase of a radius of a spiral pattern for the spiral survey operation.

11. The method of claim 1, wherein selecting the at least one design parameter comprises selecting a design parameter for a time-lapse survey.

12. The method of claim 1, wherein selecting the at least one design parameter relates to a survey data acquisition operation for survey-guided drilling of a wellbore.

13. The method of claim 1, wherein selecting the at least one design parameter comprises modifying the at least one design parameter of a survey arrangement as the survey acquisition is being performed.

14. The method of claim 1, wherein selecting the data processing strategy comprises selecting one or more subsets of a dataset containing acquired survey data, the method further comprising:
processing the selected one or more subsets of data.

15. The method of claim 14, wherein the processing is selected from the group consisting of a full waveform inversion, reverse time migration processing, least squares migration processing, tomography processing, velocity analysis, noise suppression, seismic attribute analysis, static removal, and quality control at a control system.

16. A computer system comprising:
at least one processor to:
provide an objective function based on a variation in predicted data over multiple sets of candidate model parameterizations that characterize a target structure;
perform a computation with respect to the objective function to produce an output; and
perform an action selected from the group consisting of: selecting, using the output of the computation, at least one design parameter relating to performing a survey acquisition that is one of an active source survey acquisition and a non-seismic passive survey acquisition; and selecting, using the output of the computation, a data processing strategy.

17. The computer system of claim 16, wherein the objective function includes a D_{N}-criterion.

18. The computer system of claim 17, wherein the computation comprises maximizing the D_{N}-criterion.

19. The computer system of claim 17, wherein the computation computes values pertaining to the D_{N}-criterion, wherein the values identify positions of shots that are more likely to produce more informative data.

20. The computer system of claim 16, wherein selecting the data processing strategy comprises selecting one or more subsets of a dataset containing acquired survey data, and performing processing of the selected one or more subsets.
